(19) United States
(12) Patent Application Publication
(10) Pub. No.: US 2022/0057676 A1
(43) Pub. Date: Feb. 24, 2022

(54) DISPLAY DEVICE

(71) Applicant: OSAKA UNIVERSITY, Osaka (JP)

(72) Inventors: Hiroyuki YOSHIDA, Suita-shi (JP); SeongYong CHO, Suita-shi (JP); Masanori OZAKI, Suita-shi (JP)

(73) Assignee: OSAKA UNIVERSITY, Osaka (JP)

(21) Appl. No.: 17/299,710

(22) PCT Filed: Nov. 28, 2019
(86) PCT No.: PCT/JP2019/046575

§ 371 Date: Jun. 3, 2021

(30) Foreign Application Priority Data
Dec. 4, 2018 (JP) 2018-227304

(51) Int. Cl. G02F 1/1335; G02F 1/137; G02F 1/13357; F21V 8/00

(52) U.S. Cl. CPC G02F 1/133616; G02B 6/0068; G02F 1/133621; G02F 1/137

(57) ABSTRACT

A display device includes an optical waveguide layer, a variable refractive index layer, and an optical layer. The refractive index of the variable refractive index layer changes in response to application of a drive voltage. The optical layer reflects or absorbs light. The variable refractive index layer reflects the light to be guided through the optical waveguide layer 11 toward the inside of the optical waveguide layer depending on the refractive index of the variable refractive index layer to allow the optical waveguide layer to guide the reflected light. The variable refractive index layer introduces the light to be guided through the optical waveguide layer into the variable refractive index layer depending on the refractive index of the variable refractive index layer and emits the introduced light out of the variable refractive index layer. The optical layer reflects or absorbs the light emitted from the variable refractive index layer.

### TECHNICAL FIELD

The present invention relates to a display device.

### BACKGROUND ART

Patent Literature 1 describes a waveguide-type liquid crystal device. The waveguide-type liquid crystal device includes two glass substrates, a plurality of spacers, and liquid crystal. The spacers are disposed between the two glass substrates. The liquid crystal is injected between the two glass substrates.

Each of the spacers composes a core of a waveguide. The liquid crystal composes a cladding of the waveguide. The molecular orientation of the liquid crystal is controlled by applying a voltage to the liquid crystal, thus changing a refractive index of the liquid crystal as the cladding. As a result, the propagation state of guided light propagating through the spacers each as the core can be controlled.

### CITATION LIST

### Non-Patent Literature

[Non-Patent Literature 1]
Ginga Sato, Kei Shiozawa, Yasufumi limura, “Display Application of Waveguide Propagation Light Controlled by LC Medium” (liquid crystal display, poster presentation, 2015 Japan Liquid Crystal Society Conference)

### SUMMARY OF INVENTION

### Technical Problem

However, in the waveguide-type liquid crystal device described in Non-Patent Literature 1, the transmittance of light in the cores change only by 2.5% between when voltage is applied to the liquid crystal and when no voltage is applied to the liquid crystal. That is, insufficient contrast is exhibited in the waveguide-type liquid crystal device.

The objective of the present invention is to provide a display device capable of exhibiting improved contrast.

### Solution to Problem

A display device according to one aspect of the present invention includes an optical waveguide layer, a variable refractive index layer, and an optical layer. The optical waveguide layer guides light. In the variable refractive index layer, a refractive index changes in response to application of a drive voltage. The optical layer reflects or absorbs light. The variable refractive index layer is disposed between the optical waveguide layer and the optical layer. The variable refractive index layer reflects the light to be guided through the optical waveguide layer toward the inside of the optical waveguide layer depending on the refractive index of the variable refractive index layer to allow the optical waveguide layer to guide the reflected light. The variable refractive index layer introduces the light to be guided through the optical waveguide layer into the variable refractive index layer depending on the refractive index of the variable refractive index layer and emits the introduced light out of the variable refractive index layer. The optical layer reflects or absorbs the light emitted from the variable refractive index layer.

In the display device of the present invention, the variable refractive index layer is preferably a liquid crystal layer including liquid crystal.

In the display device of the present invention, the optical layer preferably diffusely reflects the light emitted from the variable refractive index layer.

In the display device of the present invention, the optical layer preferably includes a plurality of helical structures or a layered structure. Each of the helical structures preferably extends in a direction intersecting with the variable refractive index layer. Spatial phases of two or more of the helical structures are preferably mutually different. The layered structure includes a substrate with an irregular surface and a dielectric multilayer film laminated to the surface of the substrate.

The display device of the present invention preferably further includes a light source section. The light source section preferably emits light toward the optical waveguide layer such that the light is guided through the optical waveguide layer. The light emitted by the light source section preferably includes visible light. The variable refractive index layer preferably reflects the visible light to be guided through the optical waveguide layer toward the inside of the optical waveguide layer depending on the refractive index of the variable refractive index layer to allow the optical waveguide layer to guide the reflected visible light. The variable refractive index layer preferably introduces the visible light to be guided through the optical waveguide layer into the variable refractive index layer depending on the refractive index of the variable refractive index layer and emits the introduced visible light out of the variable refractive index layer. The optical layer preferably reflects the visible light introduced from the optical waveguide layer and emitted from the variable refractive index layer. The optical waveguide layer preferably transmits ambient light incident at an angle at which the ambient light cannot be guided through the optical waveguide layer. The variable refractive index layer preferably transmits the ambient light transmitted through the optical waveguide layer. The optical layer preferably transmits visible light included in the ambient light transmitted through the variable refractive index layer.

In the display device of the present invention, the light source section preferably includes a plurality of light sources which emit visible light rays with mutually different wavelengths. The light sources emit the visible light rays toward the optical waveguide layer at mutually different timings.

In the display device of the present invention, the light source section preferably includes a white light source which emits white light. The white light source preferably emits the white light toward the optical waveguide layer. The variable refractive index layer introduces a plurality of visible light rays with mutually different wavelengths included in the white light at different angles from different positions of the variable refractive index layer depending on the refractive index of the variable refractive index layer, and emits the visible light out of the variable refractive index layer from different positions of the variable refractive index layer.

In the display device of the present invention, the optical layer preferably absorbs and colors the light emitted from the variable refractive index layer.

The display device of the present invention preferably further includes an electrode unit and a cladding layer. The electrode unit preferably applies the drive voltage to the variable refractive index layer. The cladding layer preferably has a refractive index that is smaller than the refractive index of the optical waveguide layer. The optical waveguide layer is preferably disposed between the cladding layer and the variable refractive index layer.

The display device of the present invention preferably further includes a variable absorptance layer. The variable absorptance layer preferably switches, according to an applied control voltage, between a state in which light is transmitted and a state in which light is absorbed. The variable absorptance layer is preferably disposed opposite to the variable refractive index layer with respect to the optical layer.

### Advantageous Effects of Invention

According to the present invention, a display device capable of exhibiting improved contrast can be provided.

### BRIEF DESCRIPTION OF DRAWINGS

FIG. 1 is a cross-sectional view of a display device according to a first embodiment of the present invention.

FIG. 2 is a cross-sectional view of an optical layer in the first embodiment.

FIG. 3 is a plan view of the optical layer in the first embodiment.

FIG. 4 is a plan view of a spatial phase distribution of a plurality of helical structures of the optical layer in the first embodiment.

FIG. 5A is a graph illustrating the reflectivity of light vertically incident to the optical layer in the first embodiment. FIG. 5B is a graph illustrating the transmittance of the light vertically incident to the optical layer in the first embodiment.

FIG. 6 is a cross-sectional view of an experimental system for measuring the reflectivity of the optical layer to light from a light source section in the first embodiment.

FIG. 7 is a graph illustrating a waveguide angle of an optical waveguide layer in the first embodiment.

FIG. 8A is a graph illustrating the reflectance of the optical layer when the waveguide angle is 59 degrees in the optical waveguide layer of the first embodiment.

FIG. 8B is a graph illustrating the reflectance of the optical layer when the waveguide angle is 67 degrees in the optical waveguide layer of the first embodiment. FIG. 8C is a graph illustrating the reflectance of the optical layer when the waveguide angle is 70 degrees in the optical waveguide layer of the first embodiment.

FIG. 9 is a cross-sectional view of the optical layer according to a variation of the first embodiment.

FIG. 10 is a cross-sectional view of a display device according to a second embodiment of the present invention.

FIG. 11A is a graph illustrating the reflectance of light vertically incident to the optical layer in the second embodiment. FIG. 11B is a graph illustrating the transmittance of the light vertically incident to the optical layer in the second embodiment.

FIG. 12A is a graph illustrating the reflectance of the optical layer when the waveguide angle is 70.2 degrees in the optical waveguide layer of the second embodiment. FIG. 12B is a graph illustrating the reflectance of the optical layer when the waveguide angle is 73.3 degrees in the optical waveguide layer of the second embodiment. FIG. 12C is a graph illustrating the reflectance of the optical layer when the waveguide angle is 75.2 degrees in the optical waveguide layer according to the second embodiment.

FIG. 13 is a cross-sectional view of the display device according to a first variation of the second embodiment.

FIG. 14 is a cross-sectional view of the display device according to a second variation of the second embodiment.

FIG. 15 is a cross-sectional view of a display device according to a third embodiment of the present invention.

FIG. 16 is a cross-sectional view of a display device according to a fourth embodiment of the present invention.

### DESCRIPTION OF EMBODIMENTS

Embodiments of the present invention are described below with reference to the accompanying drawings. In the drawings, a three-dimensional Cartesian coordinate system including mutually orthogonal X, Y, and Z axes is used for description. Note that elements which are the same or equivalent are labeled with the same reference signs in the drawings and description thereof is not repeated. Furthermore, diagonal lines indicating cross sections are appropriately omitted to simplify the drawings.

### First Embodiment

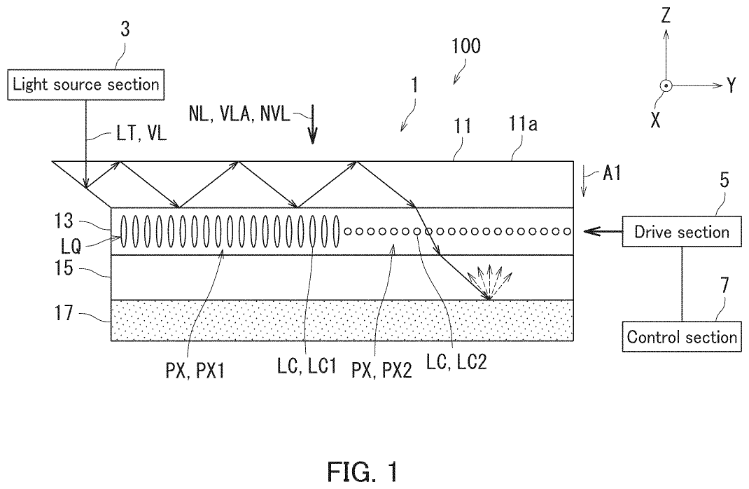

A display device 100 according to a first embodiment of the present invention is described with reference to FIGS. 1 to 8C. First, the display device 100 is described with reference to FIG. 1. FIG. 1 is a cross-sectional view of the display device 100 in the first embodiment.

As illustrated in FIG. 1, the display device 100 includes a display section 1, a light source section 3, a drive section 5, and a control section 7. The control section 7 controls the light source section 3 and the drive section 5. The control section 7 includes a controller, for example. The controller includes a processor and a storage device, for example. The processor includes a central processing unit (CPU), for example. The storage device includes a main storage device and an auxiliary storage device, for example. The main storage device includes semiconductor memory, for example. The auxiliary storage device includes a hard disk drive, for example.

The light source section 3 emits light LT. The light LT includes visible light VL. The light source section 3 includes a light emitting diode, for example. The drive section 5 applies a drive voltage Vd to the display section 1 to drive the display section 1. The drive section 5 includes a driver and a power supply circuit, for example. The drive section 5 uses an active matrix drive system or a passive matrix drive system, for example, to drive the display section 1.

The display section 1 displays an image by introducing and reflecting the light LT emitted by the light source section 3. Specifically, the display section 1 displays an image by introducing and reflecting the visible light VL emitted by the light source section 3. By contrast, the display section 1 transmits visible light VLA included in ambient light NL. That is, the display section 1 is clear and transparent. Accordingly, the display section 1 constitutes a transparent display. In the present specification, “transparent” means colorless and transparent, semi-transparent, or colored and transparent. That is, “transparent” indicates that an object positioned on the back side among front and back sides of the display section 1 is visible from the front side of the display section 1. Note that the display section 1 transmits both the visible light VL incident from the front side of the display section 1 and the visible light VL incident from the back side of the display section 1.

The ambient light NL is light other than the light LT emitted by the light source section 3. That is, the ambient light NL is light from the environment surrounding the display device 100. Accordingly, examples of the light included in the ambient light NL include natural light and light emitted by light emitting devices other than the light source section 3. A light emitting device other than the light source section 3 is a light fixture, for example. The ambient light NL does not contribute to the display of an image by the display section 1.

Specifically, the display section 1 includes an optical waveguide layer 11, a variable refractive index layer 13, and an optical layer 17. The variable refractive index layer 13 is disposed between the optical waveguide layer 11 and the optical layer 17. The display section 1 may include a substrate 15. In this case, the variable refractive index layer 13 is disposed between the optical waveguide layer 11 and the substrate 15. The optical layer 17 is disposed opposite to the variable refractive index layer 13 with respect to the substrate 15. Note that the optical layer 17 may be disposed between the variable refractive index layer 13 and the substrate 15.

The optical waveguide layer 11 guides the light LT emitted by the light source section 3. Accordingly, the light LT propagates inside the optical waveguide layer 11 while repeatedly reflecting. Specifically, the light LT propagates inside the optical waveguide layer 11 while repeatedly totally reflecting. In the present description, for the light LT to be guided inside the optical waveguide layer 11 means the same as for the light LT to propagate inside the optical waveguide layer 11.

The light LT emitted by the light source section 3 is preferably coupled to the optical waveguide layer 11 so that the light LT has a specific angle in the optical waveguide layer 11. To this end, a specific refractive structure may be provided at an edge of the optical waveguide layer 11, or a coupler including a grating may be attached to an edge of the optical waveguide layer 11 to promote coupling of light.

The optical waveguide layer 11 transmits the ambient light NL. Accordingly, the optical waveguide layer 11 is clear and transparent. For example, the optical waveguide layer 11 is composed of a transparent glass plate or a transparent synthetic resin plate. The optical waveguide layer 11 is preferably composed of a flexible transparent synthetic resin, for example. The refractive index of the optical waveguide layer 11 is greater than the refractive index of air.

The refractive index of the variable refractive index layer 13 changes in response to application of the drive voltage Vd to the variable refractive index layer 13. The variable refractive index layer 13 transmits the ambient light NL. Accordingly, the variable refractive index layer 13 is clear and transparent. The variable refractive index layer 13 is preferably flexible. The variable refractive index layer 13 is described later in detail.

The substrate 15 transmits the light LT. The substrate 15 transmits the ambient light NL. Accordingly, the substrate 15 is clear and transparent. The substrate 15 is composed of a transparent glass plate or a transparent synthetic resin plate, for example. The substrate 15 is preferably composed of a flexible transparent synthetic resin, for example.

The optical layer 17 reflects the light LT. Specifically, the optical layer 17 reflects the visible light VL included in the light LT. The optical layer 17 may transmit or reflect invisible light NVL included in the light LT. The invisible light NVL is light with a wavelength outside of the visible light spectrum. The optical layer 17 transmits the ambient light NL. Accordingly, the optical layer 17 is clear and transparent. The optical layer 17 is preferably flexible. The optical layer 17 is described later in detail.

Control of the light LT from the light source section 3 by the variable refractive index layer 13 and the optical layer 17 is described with further reference to FIG. 1.

The variable refractive index layer 13 reflects the light LT to be guided through the optical waveguide layer 11 toward the inside of the optical waveguide layer 11 depending on the refractive index of the variable refractive index layer 13 to allow the optical waveguide layer 11 to guide the reflected light LT. For example, when the refractive index of the variable refractive index layer 13 is smaller than the refractive index of the optical waveguide layer 11, the light LT to be guided through the optical waveguide layer 11 is reflected toward the inside of the optical waveguide layer 11 to allow the optical waveguide layer 11 to guide the reflected light LT. Accordingly, as long as the light LT to be guided through the optical waveguide layer 11 is reflected by the variable refractive index layer 13, the light LT is guided through the optical waveguide layer 11 and emitted from an emission end of the optical waveguide layer 11. As a result, the light LT does not enter the eyes of a person viewing the display section 1 from the side of a main surface 11a of the optical waveguide layer 11.

Note that the emission end of the optical waveguide layer 11 indicates an end opposite to an incidence end of the optical waveguide layer 11. The incidence end of the optical waveguide layer 11 indicates an end on the side on which the light LT is incident to the optical waveguide layer 11. When the refractive index of the variable refractive index layer 13 is smaller than the refractive index of the optical waveguide layer 11, the optical waveguide layer 11 functions as the core of an optical waveguide and the variable refractive index layer 13 functions as the cladding of the optical waveguide.

By contrast, the variable refractive index layer 13 introduces the light LT to be guided through the optical waveguide layer 11 into the variable refractive index layer 13 depending on the refractive index of the variable refractive index layer 13, and emits the introduced light LT out of the variable refractive index layer 13. For example, when the refractive index of the variable refractive index layer 13 is greater than the refractive index of the optical waveguide layer 11, the light LT to be guided through the optical waveguide layer 11 is introduced into the variable refractive index layer 13 and is emitted out of the variable refractive index layer 13. The light LT is then incident to the optical layer 17 through the substrate 15.

The optical layer 17 reflects the light LT emitted from the variable refractive index layer 13 toward the variable refractive index layer 13. The light LT reflected by the optical layer 17 passes through the substrate 15, the variable refractive index layer 13, and the optical waveguide layer 11, and is emitted from the main surface 11a of the optical waveguide layer 11. Accordingly, the light LT is incident to the eyes of a person viewing the display section 1 from the side of the main surface 11a of the optical waveguide layer 11. As a result, the person can see an image expressed by the light LT.

In particular, in the first embodiment, the light LT is emitted from the main surface 11a due to the optical layer 17 reflecting the light LT. Accordingly, the difference in lightness and darkness between a portion where the optical layer 17 reflects the light LT and a portion where the optical layer 17 does not reflect the light LT can be increased. As a result, the display device 100 can exhibit improved contrast and display a high-quality image. A portion that does not reflect the light LT appears transparent to a person.

The display device 100 is described in detail with further reference to FIG. 1. The optical waveguide layer 11 transmits the ambient light NL incident at an angle at which the ambient light NL cannot be guided through the optical waveguide layer 11. The variable refractive index layer 13 transmits the ambient light NL transmitted through the optical waveguide layer 11. The ambient light NL is then incident to the optical layer 17 through the substrate 15. The optical layer 17 transmits the visible light VLA included in the ambient light NL transmitted through the variable refractive index layer 13. Accordingly, in the first embodiment, the display section 1 appears transparent to a person viewing the display section 1 from the side of the main surface 11a of the optical waveguide layer 11.

In addition, in the first embodiment, the light source section 3 emits the light LT toward the optical waveguide layer 11 so that the light LT is guided through the optical waveguide layer 11. The light LT includes the visible light VL.

The variable refractive index layer 13 then reflects the visible light VL to be guided through the optical waveguide layer 11 toward the inside of the optical waveguide layer 11 depending on the refractive index of the variable refractive index layer 13 to allow the optical waveguide layer 11 to guide the reflected visible light VL. Accordingly, the visible light VL to be guided through the optical waveguide layer 11 is guided through the optical waveguide layer 11 and emitted from the emission end of the optical waveguide layer 11 as long as the visible light VL is reflected by the variable refractive index layer 13. As a result, the visible light VL is not incident to the eyes of a person viewing the display section 1 from the side of the main surface 11a of the optical waveguide layer 11.

By contrast, the variable refractive index layer 13 introduces the visible light VL to be guided through the optical waveguide layer 11 into the variable refractive index layer 13 depending on the refractive index of the variable refractive index layer 13 and emits the introduced visible light VL out of the variable refractive index layer 13. The visible light VL is then incident to the optical layer 17 through the substrate 15.

The optical layer 17 reflects the visible light VL introduced from the optical waveguide layer 11 and emitted from the variable refractive index layer 13 toward the variable refractive index layer 13. The visible light VL reflected by the optical layer 17 is transmitted through the substrate 15, the variable refractive index layer 13, and the optical waveguide layer 11, and is emitted from the main surface 11a of the optical waveguide layer 11. Accordingly, the visible light VL is incident to the eyes of a person viewing the display section 1 from the side of the main surface 11a of the optical waveguide layer 11. As a result, the person can see the image expressed by the visible light VL.

According to the first embodiment as described above with reference to FIG. 1, the image expressed by the visible light VL guided through the optical waveguide layer 11 can be displayed on the transparent display section 1. That is, the optical layer 17 reflects only the visible light VL to be guided through the optical waveguide layer 11, while transmitting the visible light VLA included in the ambient light NL. Accordingly, the display section 1 can effectively function as a transparent display.

In the first embodiment, it is preferable that the optical layer 17 diffusely reflects the light LT guided through the optical waveguide layer 11 and emitted from the variable refractive index layer 13. Specifically, it is preferable that the optical layer 17 diffusely reflects the visible light VL guided through the optical waveguide layer 11 and emitted from the variable refractive index layer 13. Accordingly, in this preferable example, the light LT, specifically the visible light VL, is not reflected in a specific direction, but is reflected in various directions. As a result, the viewing angle of the display section 1 can be wide. Note that diffuse reflection is synonymous with irregular reflection.

Additionally, in the first embodiment, the variable refractive index layer 13 is a liquid crystal layer including liquid crystal LQ. Accordingly, the refractive index of the variable refractive index layer 13 can be easily changed by controlling the orientation of the liquid crystal LQ through application of the drive voltage Vd to the variable refractive index layer 13. The liquid crystal LQ is clear and transparent. The liquid crystal LQ is preferably flexible. The liquid crystal LQ includes a plurality of liquid crystal molecules LC.

Control of the refractive index through driving of the variable refractive index layer 13 in a case in which the variable refractive index layer 13 is a liquid crystal layer including the liquid crystal LQ is described with further reference to FIG. 1. The display section 1 includes a plurality of pixels PX. The pixels PX are arranged in a grid pattern in plan view. Plan view indicates viewing the display section 1 in a direction A1. The direction A1 intersects with the variable refractive index layer 13. In the first embodiment, the direction A1 is substantially orthogonal to the variable refractive index layer 13.

Two pixels PX are illustrated in FIG. 1. Each pixel PX includes the smallest unit portion of the liquid crystal LQ (hereinafter referred to as a “minimum unit portion MU1”) and the smallest unit portion of the optical layer 17 (hereinafter referred to as a “minimum unit portion MU2”). The minimum unit portion MU1 indicates a region of the smallest unit of the liquid crystal LQ for which an orientation can be discretely controlled with the drive voltage Vd. The minimum unit portion MU2 indicates a region of the smallest unit of the optical layer 17 that is opposite to the minimum unit portion MU1 in the direction A1.

For each pixel PX, the drive section 5 controls the drive voltage Vd applied to the pixel PX to control the orientation of the liquid crystal LQ. That is, for each pixel PX, the drive section 5 controls the drive voltage Vd applied to the pixel PX to control the refractive index of the variable refractive index layer 13 (refractive index of the liquid crystal LQ). Therefore, it is possible to switch between an optical waveguide mode and a light introduction mode for each pixel PX.

The optical waveguide mode is a mode in which the light LT is guided through the optical waveguide layer 11 without being introduced to the variable refractive index layer 13. The drive section 5 controls the orientation of the liquid crystal LQ such that the variable refractive index layer 13 reflects the light LT toward the inside of the optical waveguide layer 11. As a result, the state of the pixel PX is set to the optical waveguide mode. For example, the drive section 5 can set the state of the pixel PX to the optical waveguide mode by controlling the orientation of the liquid crystal LQ such that the refractive index of the variable refractive index layer 13 becomes smaller than the refractive index of the optical waveguide layer 11.

In the pixel PX set to the light-waveguide mode, the light LT does not enter the minimum unit portion MU2 of the optical layer 17, and therefore, the minimum unit portion MU2 of the optical layer 17 does not reflect the light LT. That is, since the pixel PX does not emit light, the pixel PX appears transparent to a person. In the example of FIG. 1, the state of pixels PX1 among the pixels PX are set to the optical waveguide mode.

By contrast, the light introduction mode is a mode in which the light LT to be guided through the optical waveguide layer 11 is introduced into the variable refractive index layer 13. The drive section 5 controls the orientation of the liquid crystal LQ such that the variable refractive index layer 13 introduces the light LT from the optical waveguide layer 11 into the variable refractive index layer 13. As a result, the state of the pixel PX is set to the optical waveguide mode. For example, the drive section 5 can set the state of the pixel PX to the light introduction mode by controlling the orientation of the liquid crystal LQ such that the refractive index of the variable refractive index layer 13 becomes greater than the refractive index of the optical waveguide layer 11.

In the pixel PX set to the light introduction mode, the light LT enters the minimum unit portion MU2 of the optical layer 17 through the variable refractive index layer 13, and therefore the minimum unit portion MU2 of the optical layer 17 reflects (diffusely reflects, for example) the light LT. That is, since the pixel PX emits the light LT, the light LT emitted from the pixel PX is incident to the eyes of a person. Therefore, the pixel PX appears to be emitting light to a person. In the example in FIG. 1, the state of pixels PX2 among the pixels PX are set to the light introduction mode.

According to the first embodiment as described above with reference to FIG. 1, each pixel PX can be switched between the optical waveguide mode and the light introduction mode by controlling the orientation of the liquid crystal LQ for each pixel PX. Accordingly, each pixel PX can be switched between a non-light emission state and a light emission state. As a result, the display section 1 can display an image with the pixels PX.

A driving method of the liquid crystal LQ of the variable refractive index layer 13 is described with further reference to FIG. 1. In the example of FIG. 1, the liquid crystal LQ is negative dielectric anisotropy nematic liquid crystal. Accordingly, in the pixels PX1, the liquid crystal molecules LC are standing up in a state in which the drive voltage Vd is not being applied to the minimum unit portion MU1 of the liquid crystal LQ. As a result, the variable refractive index layer 13 reflects the light LT toward the inside of the optical waveguide layer 11. In the pixels PX2 by contrast, when the drive voltage Vd is applied to the liquid crystal LQ, the liquid crystal molecules LC are perpendicular to an electric field direction. As a result, the variable refractive index layer 13 introduces the light LT from the optical waveguide layer 11.

Note that the type of the liquid crystal LQ is not particularly limited. For example, the liquid crystal LQ may be a positive dielectric anisotropy nematic liquid crystal or ferroelectric liquid crystal. A ferroelectric liquid crystal responds faster to the drive voltage Vd than a nematic liquid crystal. By employing liquid crystal with a fast response as the liquid crystal LQ, the variable refractive index layer 13 can be driven at a high speed.

As long as the refractive index of the variable refractive index layer 13 can be changed for each pixel PX, the driving method of the liquid crystal LQ of the variable refractive index layer 13 is not particularly limited. For example, the driving method of the liquid crystal LQ is a twisted nematic (TN) driving liquid crystal mode, an in-plane switching (IPS) driving liquid crystal mode, a fringe field switching (FFS) driving liquid crystal mode, a vertical alignment (VA) driving liquid crystal mode, a multi-domain vertical alignment (MVA) driving liquid crystal mode, or a patterned vertical alignment (PVA) driving liquid crystal mode.

Furthermore, the shape of the optical waveguide layer 11 is not particularly limited as long as the optical waveguide layer 11 can guide the light LT. For example, the optical waveguide layer 11 may be a slab waveguide or a channel waveguide. A slab waveguide is a planar waveguide that covers all pixels PX. A channel waveguide includes a plurality of waveguides extending linearly in parallel to each other. In a channel waveguide, each waveguide extends linearly with a width corresponding to one pixel.

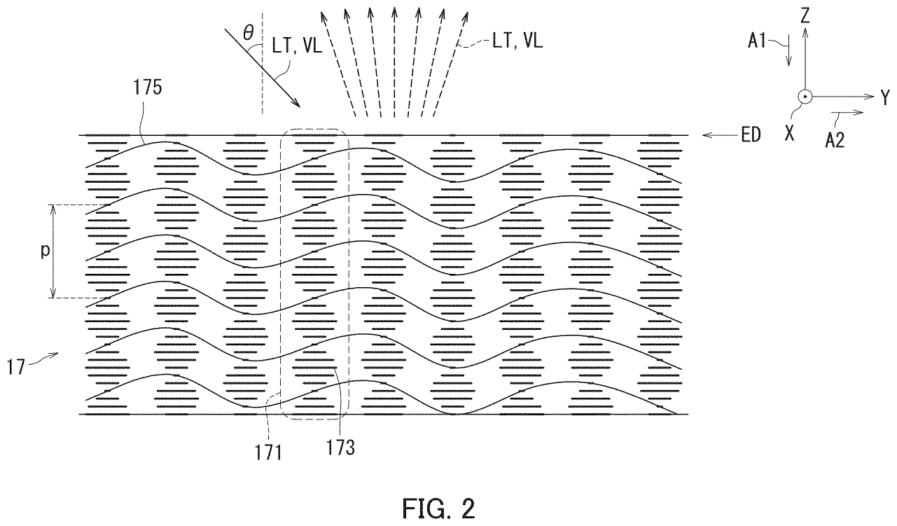

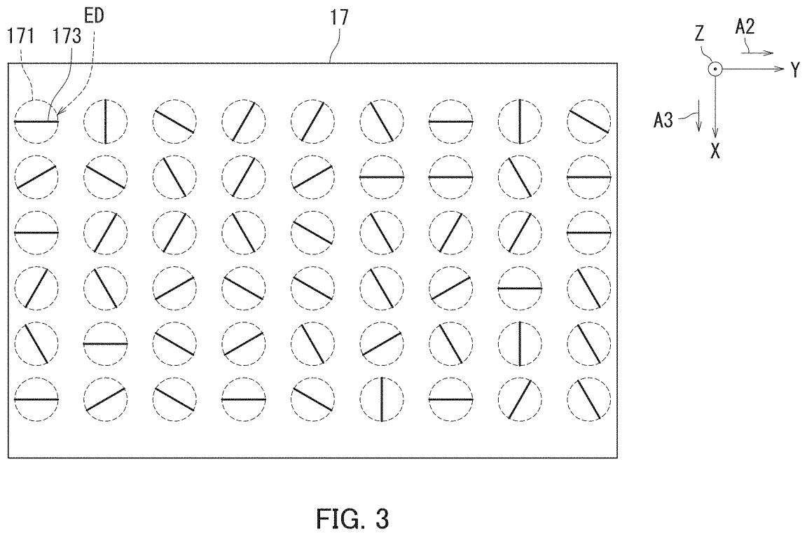

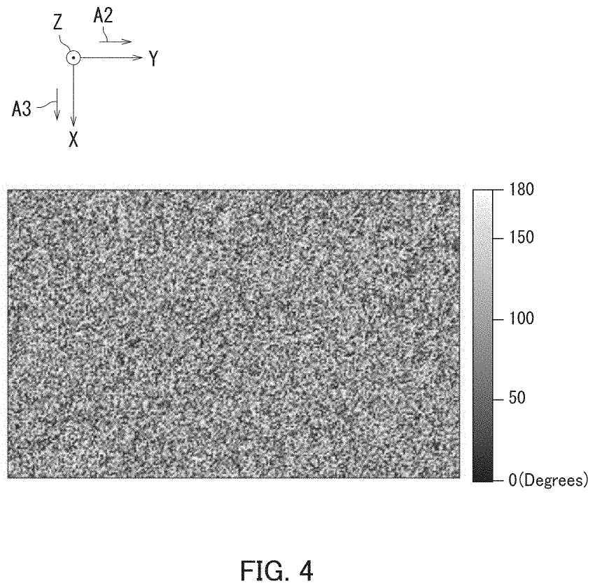

Next, the optical layer 17 is described with reference to FIGS. 2 to 4. FIG. 2 is a cross-sectional view of the optical layer 17. FIG. 3 is a plan view of the optical layer 17. FIG. 4 is a plan view illustrating the spatial phase distribution of a plurality of helical structures 171 of the optical layer 17.

As illustrated in FIG. 2, the optical layer 17 includes a plurality of helical structures 171. Each of the helical structures 171 extends in the direction A1. Each of the helical structures 171 has a pitch p. The pitch p indicates one cycle of a helix (360 degrees). Each of the helical structures 171 includes a plurality of elements 173. The elements 173 turn in helices and are stacked in the direction A1.

Each of the plurality of helical structures 171 reflects light with a wavelength in a band (hereinafter referred to as a “selective reflection band”) corresponding to the structure and optical properties of the helical structure 171. Each of the helical structures 171 has a polarization state that is consistent with the helical direction of the helix of the helical structure 171. Such reflection of light may be referred to as selective reflection, and the characteristic of selectively reflecting light may be referred to as selective reflectivity. In addition, each of the helical structures 171 transmits light in a polarization state contrary to the helical direction of the helix of the helical structure 171.

Specifically, selective reflection is as follows. That is, each of the helical structures 171 reflects light with a wavelength in a band corresponding to the pitch p and the refractive index of the helix of the helical structure 171 and with a circular polarization in the same helical direction as the helical direction of the helix of the helical structure 171. By contrast, each of the helical structures 171 transmits light with a circular polarization in the helical direction opposite to the helical direction of the helix of the helical structure 171. Note that the circularly polarized light may be strictly circularly polarized light or circularly polarized light that approximates elliptically polarized light.

The optical layer 17 has a plurality of reflective surfaces 175. Each of the reflective surfaces 175 has an irregular shape. In each of the reflective surfaces 175, the orientation direction of the elements 173 positioned in the reflective surface 175 is aligned across the helical structures 171.

Specifically, spatial phases of two or more of the helical structures 171 are mutually different. As illustrated in FIGS. 2 and 3, the spatial phase of the helical structures 171 indicates the orientation direction of the element 173 located at an end ED of each helical structure 171. The ends ED of the helical structures 171 are illustrated in FIG. 3.

According to the first embodiment, each reflective surface 175 with an irregular shape can be formed on the optical layer 17 by differentiating the spatial phases of two or more helical structures 171 from each other. As a result, even when an incidence angle θ of the light LT which is incident to the optical layer 17 is relatively large, the irregular shape of the reflective surface 175 can diffusely reflect the light LT (specifically, the visible light VL). In addition, when the optical layer 17 includes a plurality of helical structures 171, the optical layer 17 diffusely reflects the light LT as a static element. Accordingly, haze can be reduced.

Specifically, as illustrated in FIG. 3, the helical structures 171 are aligned in a direction A2 and a direction A3. The orientation direction of the helical structures 171 aligned in the direction A2 is changing irregularly. That is, the spatial phase of the helical structures 171 aligned in the direction A2 changes irregularly. In addition, the orientation direction of the helical structures 171 aligned in the direction A3 is changing irregularly. That is, the spatial phase of the helical structures 171 aligned in the direction A3 is changing irregularly. Accordingly, as illustrated in FIG. 2, reflective surfaces 175 with irregular shapes are formed. Note that the direction A1 (FIG. 1), the direction A2, and the direction A3 are mutually orthogonal.

FIG. 4 is a plan view of the spatial phase distribution of the helical structures 171. In FIG. 4, the spatial phase distribution when the optical layer 17 is viewed in the direction A1 is expressed by the rotation angle of an element 173. In FIG. 4, the phase at 0 degrees is expressed in black and the phase at 180 degrees is expressed in white. The area between 0 degrees and 180 degrees is expressed in gray with varying density. The darker the gray, the closer the value is to 0 degrees. The lighter the gray, the closer the value is to 180 degrees. As illustrated in FIG. 4, the phases of the helical structures 171 are irregularly distributed. For example, the phases of the helical structures 171 are randomly distributed.

In the first embodiment, the helical structures 171 of the optical layer 17 are molecules of cholesteric liquid crystal. Accordingly, each of the elements 173 composing a helical structure 171 is a liquid crystal molecule.

Note that the helical structures 171 of the optical layer 17 are not limited to molecules of cholesteric liquid crystal. The helical structures 171 may be molecules of chiral liquid crystal other than cholesteric liquid crystal. Examples of the chiral liquid crystal other than the cholesteric liquid crystal include chiral smectic C phase, twisted grain boundary phase, and cholesteric blue phase. Alternatively, the cholesteric liquid crystal may be helicoidal cholesteric phase, for example.

The helical structures 171 of the optical layer 17 are not limited to molecules of liquid crystal. For example, the helical structures 171 may form a chiral structure. A chiral structure is a helical inorganic material, a helical metal, or a helical crystal, for example.

The helical inorganic material is a chiral sculptured film (hereinafter referred to as “CSF”), for example. CSF is an optical thin film obtained by depositing an inorganic material on a substrate while rotating the substrate, and has a helical microstructure. As a result, the CSF exhibits optical characteristics similar to those of cholesteric liquid crystal.

The helical metal is, for example, helix metamaterial (hereinafter referred to as “HM”). HM is a material obtained by processing a metal into fine helical structures, and reflects circularly polarized light like cholesteric liquid crystal.

A helical crystal is gyroid photonic crystal (hereinafter referred to as “GPC”), for example. AGPC has a three-dimensional helical structure. Some insects or artificial structures have GPC. The GPC reflects circularly polarized light such as the cholesteric blue phase.

Note that the optical layer 17 is not limited to diffusely reflecting the light LT, and may reflect the light LT in any reflection form. In other words, the optical layer 17 can reflect the light LT in any reflection form depending on the spatial phase distribution of the helical structures 171. In yet other words, the shape of the reflective surfaces 175 is not limited to an irregular shape, but may take any shape. For example, the optical layer 17 can be configured as a volume hologram. When the optical layer 17 is configured as a volume hologram, the reflective surface 175 reflects the light LT (specifically, the visible light VL) to form an image of an object corresponding to the light LT.

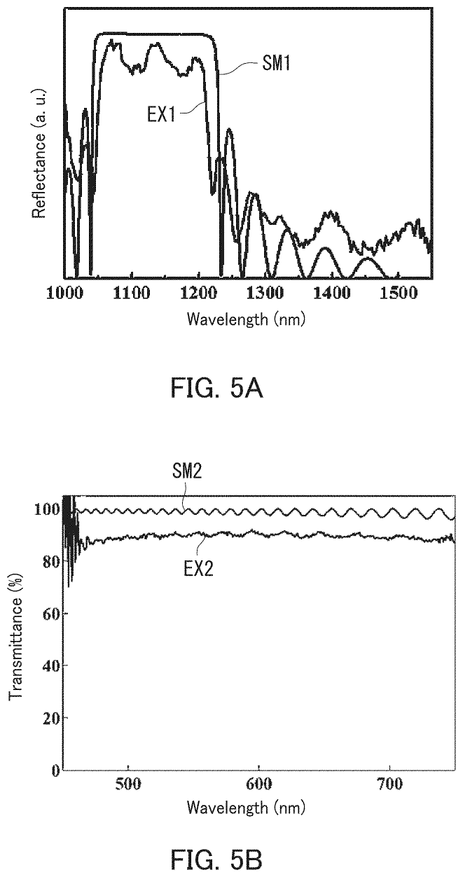

Next, the reflectance and the transmittance of the ambient light NL by the optical layer 17 is are described with reference to FIGS. 5A and 5B. The present inventors measured the reflectance and the transmittance of the optical layer 17 when the liquid crystal LQ of the optical layer 17 was cholesteric liquid crystal. The cholesteric liquid crystal had the structure illustrated in FIGS. 2 to 4. Light was then incident orthogonally to the optical layer 17. Note that the optical waveguide layer 11 and the variable refractive index layer 13 were not provided.

FIG. 5A is a graph illustrating the reflectance of light incident to the optical layer 17. In FIG. 5A, the vertical axis indicates the reflectance of the light (in arbitrary units), and the horizontal axis indicates the wavelength of the light (nm). A curve SM1 indicates a simulation result of the reflectance, and a curve EX1 indicates a measurement result of the reflectance.

FIG. 5B is a graph illustrating the transmittance of the light incident to the optical layer 17. The vertical axis in FIG. 5B illustrates the transmittance (%) of the light, and the horizontal axis shows the wavelength (nm) of the light. A curve SM2 indicates a simulation result of the transmittance, and a curve EX2 indicates a measurement result of the transmittance.

As illustrated in FIG. 5A, the cholesteric liquid crystal that constituted the optical layer 17 reflected light with wavelengths in the near-infrared range. As illustrated in FIG. 5A by contrast, the cholesteric liquid crystal that constituted the optical layer 17 transmitted light with wavelengths in the visible light range. Accordingly, it could be inferred that the display section 1 functions as a transparent display because the visible light VLA included in the ambient light NL illustrated in FIG. 1 is transmitted through the optical layer 17 without being reflected by the optical layer 17. Note that even if the optical layer 17 reflects the near-infrared light contained in the ambient light NL, it is not visible to a person.

Here, the reflection by cholesteric liquid crystal is Bragg reflection. The wavelength of Bragg reflection by the cholesteric liquid crystal shifts to the shorter wavelength side as the incidence angle to the cholesteric liquid crystal increases. However, the optical waveguide layer 11, the variable refractive index layer 13, the substrate 15, and the optical layer 17 are designed such that Bragg reflection does not occur at incidence angles in the range that can be taken by the visible light VLA included in the ambient light NL illustrated in FIG. 1. Accordingly, the visible light VLA included in the ambient light NL is not reflected by the optical layer 17. Furthermore, cholesteric liquid crystal does not exhibit high-order Bragg reflection because of its helical structure. Accordingly, high-order Bragg reflection of the visible light VLA does not occur. Note that the incidence angle indicates an incidence angle of light relative to a vertical line perpendicular to the surface of the cholesteric liquid crystal.

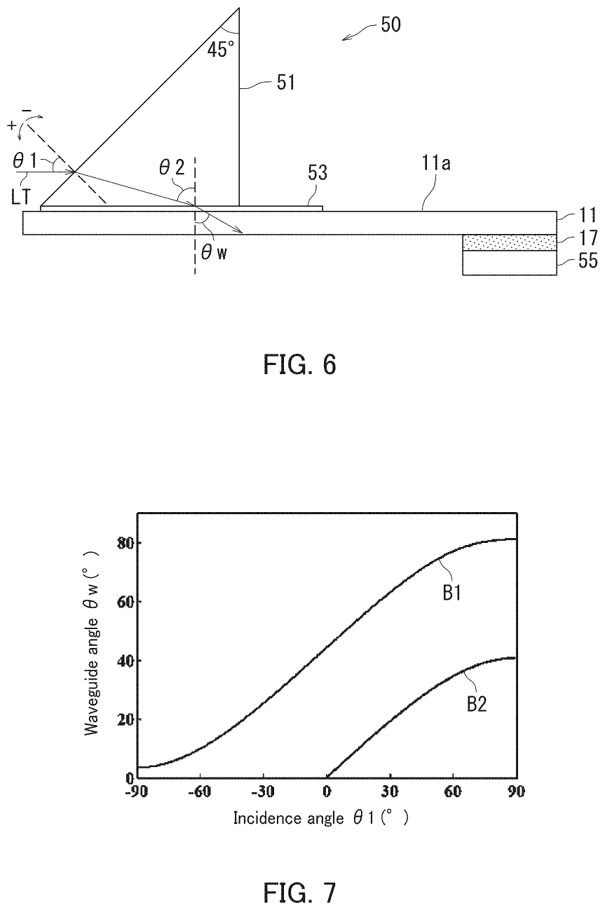

Next, the reflectance of the light LT from the light source section 3 by the optical layer 17 is described with reference to FIGS. 6 to 8C. The present inventors measured the reflectance of the optical layer 17 when the liquid crystal LQ of the optical layer 17 was cholesteric liquid crystal. The cholesteric liquid crystal had the structure illustrated in FIGS. 2 to 4. A cholesteric liquid crystal was used that showed reflection at about 1150 nm when light was vertically incident. Furthermore, an experimental system 50 illustrated in FIG. 6 was used.

FIG. 6 is a cross-sectional view of an experimental system 50 for measuring the reflectance of the light LT from the light source section 3 by the optical layer 17. As illustrated in FIG. 6, the experimental system 50 included a prism 51, a transparent oil 53, an optical waveguide layer 11, an optical layer 17, and a transparent substrate 55. The prism 51 and the optical waveguide layer 11 were in close contact with each other with the oil 53 therebetween. The optical layer 17 was disposed between the optical waveguide layer 11 and the substrate 55.

The refractive index of air was approximately 1.00. The refractive index of each of the prism 51, the oil 53, and the optical waveguide layer 11 was approximately 1.53. The refractive index of the cholesteric liquid crystal in the optical layer 17 was approximately 1.60.

An incidence angle θ1 of the light LT to the prism 51 was defined with respect to a vertical line perpendicular to a slanting surface of the prism 51. A side closer to the optical waveguide layer 11 with respect to the perpendicular line was taken to be a “positive” side of the incidence angle θ1, and a side farther from the optical waveguide layer 11 with respect to the perpendicular line was taken to be a “negative” side of the incidence angle θ1.

An incidence angle θ2 of the light LT to the optical waveguide layer 11 was defined with respect to a vertical line perpendicular to the main surface 11a of the optical waveguide layer 11. Furthermore, an effective incidence angle θw of the light LT to the optical waveguide layer 11 was defined with respect to the vertical line orthogonal to the main surface 11a of the optical waveguide layer 11. The effective incidence angle θw indicated a refracting angle of the light LT. Since the light LT satisfied the waveguide conditions in the optical waveguide layer 11, the light LT was guided through the optical waveguide layer 11 at the effective incidence angle θw.

In the following, the effective incidence angle θw may be referred to as a “waveguide angle θw”.

Here, the waveguide angle θw of the light LT in the optical waveguide layer 11 varies with the incidence angle θ1 according to Snell's law for refraction of light rays.

FIG. 7 is a graph illustrating the relationship between the incidence angle θ1 and the waveguide angle θw in the experimental system 50. In FIG. 7, the vertical axis indicates the waveguide angle θw (degrees) and the horizontal axis indicates the incidence angle θ1 (degrees). A curve B1 indicates a calculation result of the waveguide angle θw in the experimental system 50 with the prism 51. A curve B2 indicates a calculation result of the waveguide angle θw in the experimental system 50 without the prism 51. In the experimental system 50, a large waveguide angle θw can be realized according to the specification of the prism 51.

A critical angle θc indicating total reflection in the optical waveguide layer 11 is θc=sin−1(1/1.53)≈40.8 degrees, so it could be inferred that the light LT will be guided through the optical waveguide layer 11 when the incidence angle θ1 is larger than “−10 degrees” as illustrated in FIG. 7.

The reflectivity is described with further reference to FIG. 6. Using the experimental system 50, the present inventors measured the reflectance of the optical layer 17 when the waveguide angle θw was 59 degrees, when the waveguide angle θw was 67 degrees, and when the waveguide angle θw was 70 degrees. From the curve B1 illustrated in FIG. 7, it could be confirmed that when the incidence angle θ1 was set to 18 degrees, the waveguide angle θw could be set to 59 degrees. From the curve B1, it could be confirmed that when the incidence angle θ1 was set to 30 degrees, the waveguide angle θw could be set to 67 degrees. From the curve B1, it could be confirmed that when the incidence angle θ1 was set to 35 degrees, the waveguide angle θw could be set to 70 degrees.

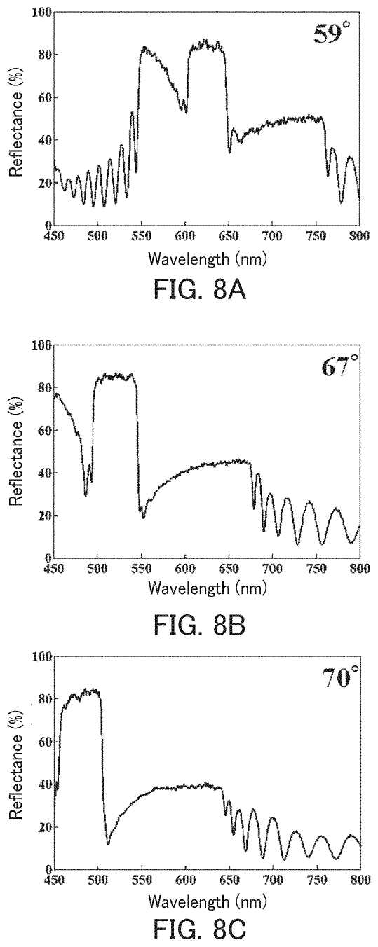

FIG. 8A is a graph illustrating the reflectance of the optical layer 17 when the waveguide angle θw in the optical waveguide layer 11 was 59 degrees. FIG. 8B is a graph illustrating the reflectance of the optical layer 17 when the waveguide angle θw in the optical waveguide layer 11 was 67 degrees. FIG. 8C is a graph illustrating the reflectance of the optical layer 17 when the waveguide angle θw in the optical waveguide layer 11 was 70 degrees. In FIGS. 8A to 8C, the vertical axis indicates the reflectance (%) of the light LT, and the horizontal axis illustrates the wavelength (nm) of the light LT.

When the waveguide angle θw was 59 degrees, the reflectance of the light LT in the optical layer 17 was particularly large (approximately 80%) in the wavelength band corresponding to red (central wavelength: approximately 625 nm) as illustrated in FIG. 8A. Red diffuse reflected light from the optical layer 17 could be visually confirmed.

When the waveguide angle θw was 67 degrees, the reflectance of the light LT in the optical layer 17 was particularly large (approximately 80%) in the wavelength band corresponding to green (central wavelength: approximately 520 nm) as illustrated in FIG. 8B. Green diffuse reflected light from the optical layer 17 could be visually confirmed.

When the waveguide angle θw was 70 degrees, the reflectance of the light LT in the optical layer 17 was particularly large (approximately 80%) in the wavelength band corresponding to blue (central wavelength: approximately 475 nm) as illustrated in FIG. 8C. Blue diffuse reflected light from the optical layer 17 could be visually confirmed.

As illustrated in FIGS. 8A to 8C, the reflection wavelength of the optical layer 17 fell into a reflection band that shifted to a short wavelength side corresponding to the waveguide angle θw. In particular, as the waveguide angle θw increased, the reflection band shifted to the short wavelength side. Strong red reflection occurred when the waveguide angle θw was 59 degrees, strong green reflection occurred when the waveguide angle θw was 67 degrees, and strong blue reflection occurred when the waveguide angle θw was 70 degrees. From the measurement results illustrated in FIGS. 8A to 8C, it could be inferred that color display is possible through a design in which the light LT of the light source section 3 is incident to the optical waveguide layer 11 at different angles depending on the wavelength thereof.

When light is incident to a cholesteric liquid crystal from an input medium, light refraction occurs in the cholesteric liquid crystal such that the phases of the light waves match at the interface between the input medium and the cholesteric liquid crystal.

### Variation

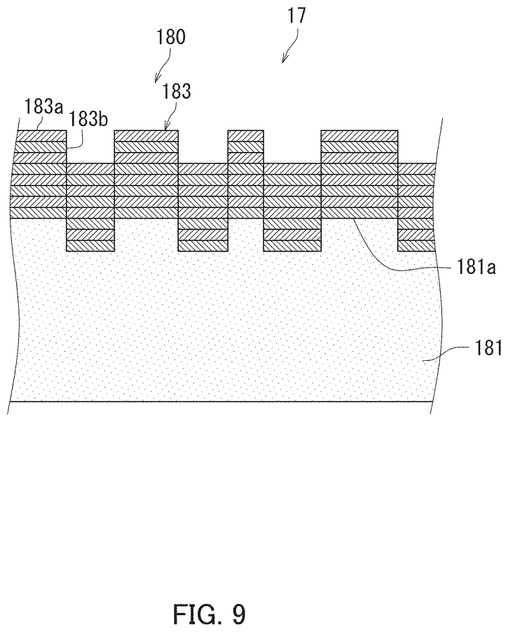

Next, the optical layer 17 according to a variation of the first embodiment is described with reference to FIGS. 1 and 9. The variation mainly differs from the first embodiment described with reference to FIG. 1 in that the optical layer 17 in the variation has a layered structure 180. The following describes the main points of difference between the variation and the first embodiment.

FIG. 9 is a cross-sectional view of the optical layer 17 in the variation. As illustrated in FIG. 9, the optical layer 17 has a layered structure 180. The layered structure 180 includes a substrate 181 and a dielectric multilayer film 183. The substrate 181 has an irregular surface 181a. The dielectric multilayer film 183 is laminated to the surface 181a of the substrate 181. Accordingly, the surface of the dielectric multilayer film 183 has an irregular shape. As a result, according to the variation, even when the incidence angle of the light LT incident to the optical layer 17 is relatively large, the irregular shape of the dielectric multilayer film 183 enables diffuse reflection of the light LT.

Specifically, the dielectric multilayer film 183 includes a plurality of first dielectrics 183a and a plurality of second dielectrics 183b. The first dielectrics 183a and the second dielectrics 183b are alternately stacked on each other. The first dielectrics 183a are TiO₂, for example. The second dielectrics 183b are SiO₂, for example. The dielectric multilayer film 183 and the substrate 181 are both clear and transparent. The dielectric multilayer film 183 and the substrate 181 are both preferably flexible.

### Second Embodiment

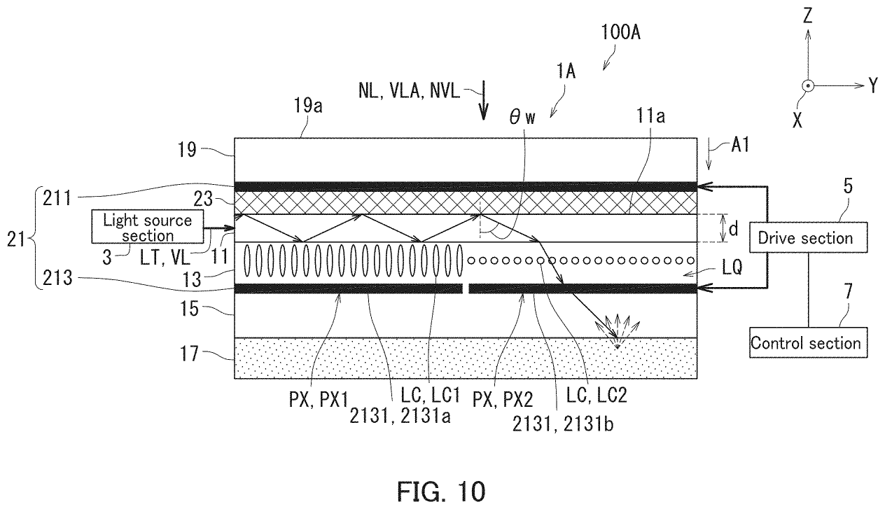

A display device 100A according to a second embodiment of the present invention is described with reference to FIG. 10. The second embodiment mainly differs from the first embodiment in that the display device 100A in the second embodiment has a cladding layer 23. The following describes the main points of difference between the second embodiment and the first embodiment.

FIG. 10 is a cross-sectional view of the display device 100A in the second embodiment. As illustrated in FIG. 10, the display device 100A includes a display section 1A instead of the display section 1 of the display device 100 illustrated in FIG. 1. In addition to the configuration of the display section 1 illustrated in FIG. 1, the display section 1A further includes an electrode unit 21 and a cladding layer 23.

The optical waveguide layer 11 is disposed between the cladding layer 23 and the variable refractive index layer 13. The cladding layer 23 has a refractive index that is smaller than the refractive index of the optical waveguide layer 11. Therefore, according to the second embodiment, the optical waveguide layer 11 can effectively guide the light LT by total reflection while reducing loss of the light LT.

The electrode unit 21 applies the drive voltage Vd to the variable refractive index layer 13. Specifically, when the drive section 5 supplies the drive voltage Vd to the electrode unit 21, the electrode unit 21 applies the drive voltage Vd to the variable refractive index layer 13. As a result, the refractive index of the variable refractive index layer 13 changes in response to the application of the drive voltage Vd.

Specifically, the orientation of the liquid crystal molecules LC changes in response to the application of the drive voltage Vd. As a result, the refractive index of the variable refractive index layer 13 changes. The electrode unit 21 is clear and transparent. The electrode unit 21 is composed of indium tin oxide (ITO), for example. The electrode unit 21 is preferably flexible. Note that in FIG. 10, the electrode unit 21 is illustrated in black to facilitate understanding of the disposal thereof.

Specifically, the electrode unit 21 includes a counter electrode 211 and a pixel electrode group 213. The pixel electrode group 213 includes a plurality of pixel electrodes 2131. The pixel electrodes 2131 are disposed on the same plane. The display section 1A includes a plurality of thin film transistors (TFTs), which are omitted to simplify the drawing. The TFTs are connected to the respective pixel electrodes 2131. Accordingly, the display section 1A employs an active matrix drive system. However, as in the first embodiment, the driving method of the display section 1A is not particularly limited.

The counter electrode 211 faces the pixel electrode group 213 through the cladding layer 23, the optical waveguide layer 11, and the variable refractive index layer 13. That is, the cladding layer 23, the optical waveguide layer 11, and the variable refractive index layer 13 are disposed between the counter electrode 211 and the pixel electrode group 213.

The display section 1 may further include a substrate 19. In this case, the counter electrode 211, the cladding layer 23, the optical waveguide layer 11, the variable refractive index layer 13, and the pixel electrode group 213 are disposed between the substrate 19 and the substrate 15. The counter electrode 211 is disposed between the substrate 19 and the cladding layer 23. The pixel electrode group 213 is disposed between the variable refractive index layer 13 and the substrate 15. The optical layer 17 is disposed opposite to the variable refractive index layer 13 with respect to the substrate 15. The variable refractive index layer 13 is disposed between the optical waveguide layer 11 and the optical layer 17. Note that the optical layer 17 may be disposed between the pixel electrode group 213 and the substrate 15.

Pixels PX in the case in which the variable refractive index layer 13 is a liquid crystal layer containing the liquid crystal LQ are described with further reference to FIG. 10. The display section 1A includes a plurality of pixels PX. The pixels PX are arranged in a grid pattern in plan view. Two pixels PX are illustrated in FIG. 10. As in the first embodiment, each pixel PX includes a minimum unit portion MU1 of the liquid crystal LQ and a minimum unit portion MU2 of the optical layer 17. Each pixel PX also includes a pixel electrode 2131 and a TFT. Each of the minimum unit portion MU1 of the liquid crystal LQ and the minimum unit portion MU2 of the optical layer 17 faces a corresponding one of the pixel electrodes 2131 in the direction A1. The pixel electrodes 2131 are each disposed between a corresponding one of the minimum unit portions MU1 of the liquid crystal LQ and a corresponding one of the minimum unit portions MU2 of the optical layer 17.

The drive section 5 controls the orientation of the liquid crystal LQ for each pixel PX by controlling the drive voltage Vd for each pixel electrode 2131 applied to the corresponding pixel electrode 2131 via the corresponding TFT. In other words, the drive section 5 controls the refractive index of the variable refractive index layer 13 (refractive index of the liquid crystal LQ) for each pixel PX by controlling the drive voltages Vd applied to the pixel electrodes 2131 via the TFTs for the respective pixel electrodes 2131. Therefore, as in the first embodiment, each pixel PX can be switched between the optical waveguide mode and the light introduction mode. As a result, in the second embodiment, as in the first embodiment, each pixel PX can be switched between the non-light emission state and the light emission state, and the display section 1A can display an image with the pixels PX.

In the second embodiment, as in the first embodiment, the optical layer 17 reflects the light LT, and the light LT is thus emitted from the main surface 11a of the optical waveguide layer 11. Accordingly, the display device 100A can exhibit improved contrast and can display a high-quality image. Otherwise, the display device 100A has the same configuration as the display device 100 in the first embodiment, and thus has the same effects as the display device 100.

The operation of the display section 1A is described with further reference to FIG. 10. The light source section 3 emits the light LT toward the optical waveguide layer 11. Accordingly, the light LT is guided inside the optical waveguide layer 11.

The variable refractive index layer 13 reflects the light LT to be guided through the optical waveguide layer 11 toward the inside of the optical waveguide layer 11 depending on the refractive index of the variable refractive index layer 13 to allow the optical waveguide layer 11 to guide the reflected light LT. In the example of FIG. 10, the light LT is not introduced into the variable refractive index layer 13 in the pixel PX1. Therefore, the pixel PX1 is not emitting light and is transparent. Note that the pixel electrode 2131 in the pixel PX1 is a pixel electrode 2131a.

By contrast, the variable refractive index layer 13 introduces the light LT to be guided through the optical waveguide layer 11 into the variable refractive index layer 13 depending on the refractive index of the variable refractive index layer 13, and emits the introduced light LT out of the variable refractive index layer 13. In the example of FIG. 10, the light LT is introduced into the variable refractive index layer 13 and the light LT is being incident to the optical layer 17 in the pixel PX2. The light LT is then incident to the optical layer 17 through a pixel electrode 2131b and the substrate 15.

In the pixel PX2, the optical layer 17 reflects the light LT (the visible light VL, for example) emitted from the variable refractive index layer 13 toward the variable refractive index layer 13. The light LT reflected by the optical layer 17 passes through the substrate 15, the pixel electrode 2131b, the variable refractive index layer 13, the optical waveguide layer 11, the cladding layer 23, the counter electrode 211, and the substrate 19, and is emitted from a main surface 19a of the substrate 19. Therefore, the light LT is incident to the eyes of a person viewing the pixel PX2 from the side of the main surface 19a of the substrate 19. That is, the pixel PX2 appears to be emitting light to a person.

The display section 1A is described in detail with further reference to FIG. 10. The refractive index of the cladding layer 23 is referred to as “nc”, and the refractive index of the optical waveguide layer 11 is referred to as “nw”. The refractive index of the liquid crystal LQ to extraordinary light when no voltage is applied is referred to as “ne”, and the refractive index of the liquid crystal LQ to ordinary light when no voltage is applied is referred to as “no”. Also, the thickness of the optical waveguide layer 11 is referred to as “d”. The optical layer 17 includes cholesteric liquid crystal.

The light LT with a wavelength λ emitted by the light source section 3 is guided in the optical waveguide layer 11 only at a waveguide angle θw that satisfies Formulas (1), (2), and (3). That is, only discrete waveguide angles θw are allowed, depending on the refractive index nc, the refractive index nw, the refractive index no, and the thickness d of the optical waveguide layer 11. Formula (1) indicates a total reflection condition at the interface between the optical waveguide layer 11 and the cladding layer 23 when the light LT is guided in the optical waveguide layer 11. Formula (2) indicates a total reflection condition at the interface between the optical waveguide layer 11 and the variable refractive index layer 13 when the light LT is guided in the optical waveguide layer 11. Formula (3) indicates a phase matching condition in the optical waveguide layer 11. In Formula (1), “θcc” represents a critical angle for total reflection at the interface between the optical waveguide layer 11 and the cladding layer 23 in the optical waveguide layer 11. In Formula (2), “θco” represents a critical angle for total reflection at the interface between the optical waveguide layer 11 and the variable refractive index layer 13 in the optical waveguide layer 11. In Equation (3), “φc” represents a phase change associated with the reflection at the interface between the optical waveguide layer 11 and the cladding layer 23, “φo” represents a phase change associated with the reflection at the interface between the optical waveguide layer 11 and the variable refractive index layer 13, and “m” represents an integer.

[Formula 1]

$$\begin{matrix}θw > {sin}^{- 1} ( \frac{n c}{n w} ) = θ cc & ( 1 ) \\ [ Formula 2 ] & \\ θw > {sin}^{- 1} ( \frac{n o}{n w} ) = θ co & ( 2 ) \\ [ Formula 3 ] & \\ tan ( \frac{ϕ c + ϕ o}{2} ) = tan ( \frac{2 π}{λ} d cos ( θ w ) - m π ) & ( 3 )\end{matrix}$$

When the light LT to be guided through the optical waveguide layer 11 is introduced to the variable refractive index layer 13 by driving the liquid crystal LQ of the variable refractive index layer 13, the light LT passes through the variable refractive index layer 13, the pixel electrodes 2131, and the substrate 15, and is incident to the cholesteric liquid crystal of the optical layer 17 at an incidence angle corresponding to the waveguide angle θw. Accordingly, the reflection wavelength of the light LT by the cholesteric liquid crystal of the optical layer 17 falls into a reflection band shifted to the short wavelength side corresponding to the waveguide angle θw, relative to the reflection band at time of vertical incidence. Specifically, the reflection wavelength of the light LT by the cholesteric liquid crystal of the optical layer 17 shifts to the short wavelength side as the waveguide angle θw increases.

The present inventors calculated the reflectance and the transmittance of the optical layer 17 when light was vertically incident to the optical layer 17 by simulation. In this case, the light was a TE wave. The refractive index nc was 1.49, the refractive index nw was 1.60, the refractive index ne was 1.84, the refractive index no was 1.57, the thickness d was 9 μm, and the helical pitch p of the liquid crystal LQ was 1000 nm.

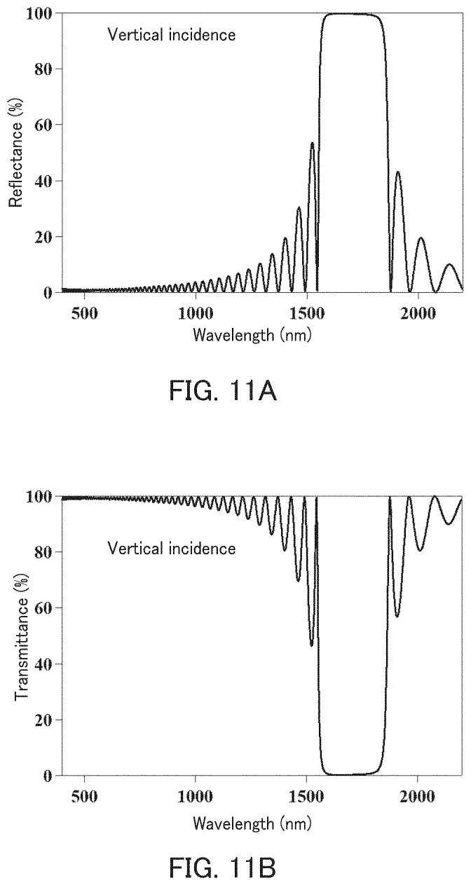

FIG. 11A is a graph illustrating the reflectance of the optical layer 17 when light is vertically incident to the optical layer 17. In FIG. 11A, the vertical axis indicates the reflectance (%) of light, and the horizontal axis indicates the wavelength (nm) of light. FIG. 11B is a graph illustrating the transmittance of the optical layer 17 when light is vertically incident to the optical layer 17. In FIG. 11B, the vertical axis indicates the transmittance (%) of light, and the horizontal axis indicates the wavelength (nm) of light.

As illustrated in FIG. 11A, the reflectance of light in the optical layer 17 was 100% in the near-infrared region. As illustrated in FIG. 11B, the transmittance of light in the optical layer 17 was 100% in the visible light region. Accordingly, it could be confirmed that the optical layer 17 transmits the visible light VLA included in the ambient light NL without reflecting the visible light VLA. That is, it could be confirmed that the display section 1A is transparent to the visible light VLA included in the ambient light NL.

Furthermore, the present inventors calculated the reflectivity of the optical layer 17 when the light LT guided through the optical waveguide layer 11 was incident to the optical layer 17 by simulation. In this case, the light LT was a TE wave. The refractive index nc was 1.49, the refractive index nw was 1.60, the refractive index ne was 1.84, the refractive index no was 1.57, the thickness d was 10 μm, and the helical pitch p was 1050 nm.

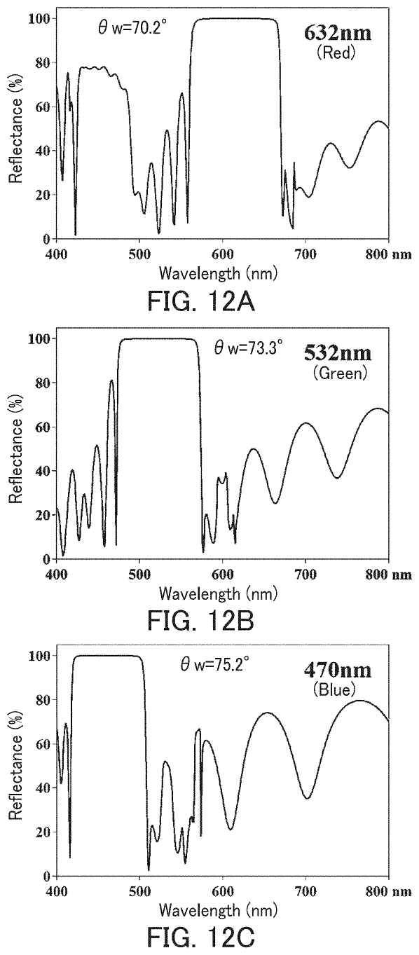

FIG. 12A is a graph illustrating the reflectance of the optical layer 17 when the waveguide angle θw of the optical waveguide layer 11 was 70.2 degrees. FIG. 12B is a graph illustrating the reflectance of the optical layer 17 when the waveguide angle θw of the optical waveguide layer 11 was 73.3 degrees. FIG. 12C is a graph illustrating the reflectance of the optical layer 17 when the waveguide angle θw of the optical waveguide layer 11 was 75.2 degrees. In FIGS. 12A to 12C, the vertical axis indicates the reflectance (%) of the light LT, and the horizontal axis indicates the wavelength (nm) of the light LT.

When the waveguide angle θw was 70.2 degrees, the reflectance of the light LT in the optical layer 17 was particularly large (approximately 100%) in the wavelength band corresponding to red (central wavelength: 632 nm) as illustrated in FIG. 12A.

When the waveguide angle θw was 73.3 degrees, the reflectance of the light LT in the optical layer 17 was particularly large (approximately 100%) in the wavelength band corresponding to green (central wavelength: 532 nm) as illustrated in FIG. 12B.

When the waveguide angle θw was 75.2 degrees, the reflectance of the light LT in the optical layer 17 was particularly large (approximately 100%) in the wavelength band corresponding to blue (central wavelength: 470 nm) as illustrated in FIG. 12C.

As illustrated in FIGS. 12A to 12C, the reflection wavelength of the optical layer 17 fell into a reflection band that was shifted to the short wavelength side corresponding to the waveguide angle θw. In particular, as the waveguide angle θw increased, the reflection band shifted to the short wavelength side. Strong red reflection occurred when the waveguide angle θw was 70.2 degrees, strong green reflection occurred when the waveguide angle θw was 73.3 degrees, and strong blue reflection occurred when the waveguide angle θw was 75.2 degrees. From the simulation results shown in FIGS. 12A to 12C, it could be inferred that color display is possible through a design in which the light LT of the light source section 3 is incident to the optical waveguide layer 11 at different angles depending on the wavelength thereof.

### First Variation

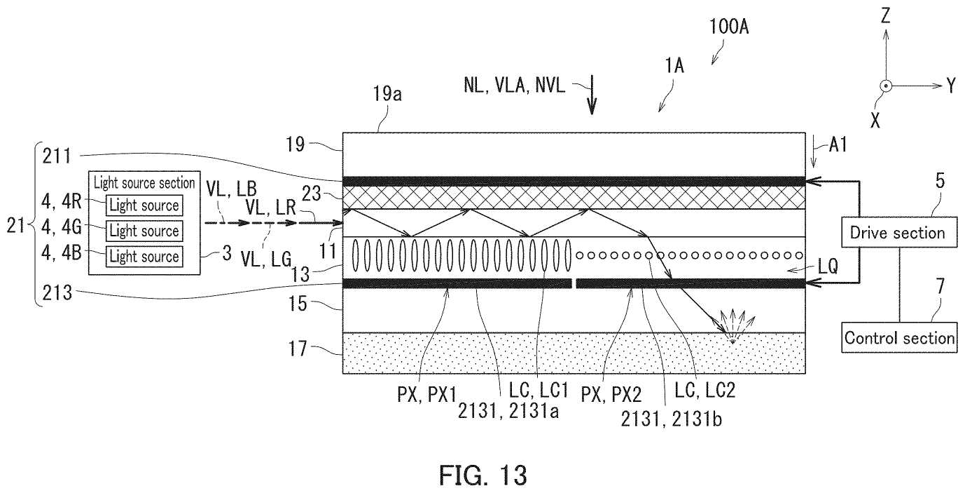

The display device 100A according to a first variation of the second embodiment is described with reference to FIG. 13. The first variation mainly differs from the display device 100A in the second embodiment described with reference to FIG. 10 in that the display device 100A in the first variation performs color display with a time-division system. The following describes the main points of difference between the first variation and the second embodiment.

FIG. 13 is a cross-sectional view of the display device 100A in the first variation. As illustrated in FIG. 13, the light source section 3 of the display device 100A includes a plurality of light sources 4. The light sources 4 include light emitting diodes, for example. The light sources 4 emit visible light rays VL with a plurality of respective mutually different wavelengths. Specifically, the light sources 4 emit the visible light rays VL toward the optical waveguide layer 11 at mutually different timings. That is, the light sources 4 emit the visible light rays VL toward the optical waveguide layer 11 through time-division. Accordingly, the visible light rays VL are guided through the optical waveguide layer 11 in the order in which they are emitted from the light source section 3. The visible light rays VL having mutually different wavelengths are guided through the optical waveguide layer 11 at mutually different waveguide angles. Note that the light sources 4 preferably emit visible light rays VL that are transverse-electric (TE) polarized. This is to facilitate optical design.

The variable refractive index layer 13 introduces visible light rays VL to be guided through the optical waveguide layer 11 into the variable refractive index layer 13 in the order of emission from the light source section 3 depending on the refractive index of the variable refractive index layer 13, and then emits the visible light rays VL out of the variable refractive index layer 13. Specifically, the visible light rays VL are emitted from the same position in the variable refractive index layer 13 in the order of emission from the light source section 3. Then, the visible light rays VL are incident to the optical layer 17 through the pixel electrode 2131 and the substrate 15 in the order of emission from the light source section 3.

The optical layer 17 reflects the visible light rays VL emitted from the variable refractive index layer 13 toward the variable refractive index layer 13 in the order of emission from the light source section 3 from the same position in the optical layer 17. In the first variation, the optical layer 17 diffusely reflects the visible light rays VL emitted from the variable refractive index layer 13 toward the variable refractive index layer 13 in the order of emission from the light source section 3 from the same position of the optical layer 17. Accordingly, the diffusely reflected visible light rays VL with the mutually different wavelengths are incident to the eyes of a person viewing the display section 1 from the side of the main surface 19a of the substrate 19 in the order of emission from the light source section 3. The emission timing of the visible light rays VL from the light source section 3 is simultaneous for the eyes of a person. As a result, the person can see a color image expressed by the visible light rays VL.

Specifically, the light source section 3 switches the wavelengths of the visible light rays VL to be emitted through time-division. The drive section 5 drives the variable refractive index layer 13 in synchronization with the switching of the wavelengths of the visible light rays VL, thereby reflecting the visible light rays VL at a desired pixel PX.

In particular, in the first variation, among the light sources 4, a light source 4R emits red visible light LB, a light source 4G emits green visible light LG, and a light source 4B emits blue visible light LB. Accordingly, in a pixel PX to which the light introduction mode is set, the optical layer 17 diffusely reflects the visible light LB, the visible light LG, and the visible light LB emitted through time-division. As a result, the display section 1A can perform color display using the visible light LB, the visible light LG, and the visible light LB. That is, in the display section 1A, the visible light LB, the visible light LG, and the visible light LB are diffusely reflected from one pixel PX to which the light introduction mode is set, thereby performing color display.

### Second Variation

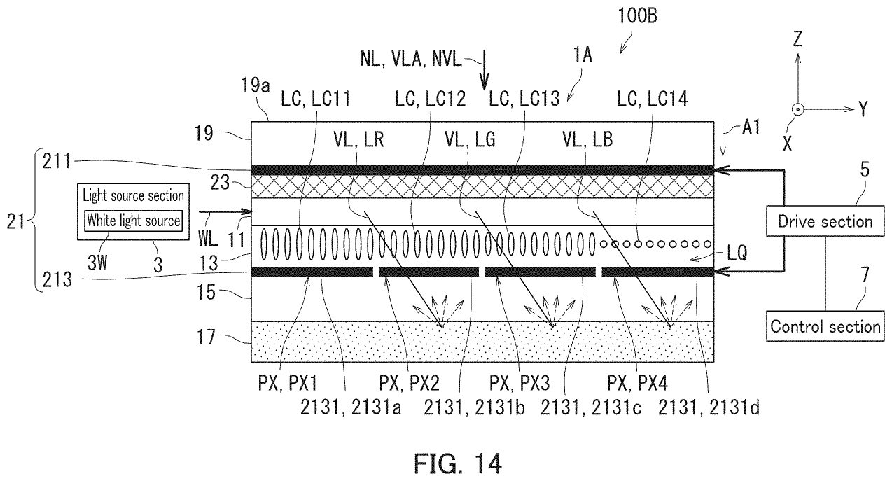

The display device 100A according to a second variation of the second embodiment is described with reference to FIG. 14. The second variation mainly differs from the display device 100A in the second embodiment described with reference to FIG. 10 in that the display device 100A in the second variation performs color display with a space-division system. The following describes the main points of difference between the second variation and the second embodiment.

FIG. 14 is a cross-sectional view of the display device 100A in the second variation. As illustrated in FIG. 14, the light source section 3 of the display device 100A includes a white light source 3W. The white light source 3W includes a light emitting diode, for example. The white light source 3W emits white light WL. The white light source 3W emits the white light WL toward the optical waveguide layer 11. Accordingly, the white light WL is guided through the optical waveguide layer 11.

The variable refractive index layer 13 introduces a plurality of visible light rays VL with mutually different wavelengths included in the white light WL into the variable refractive index layer 13 at different angles from different positions in the variable refractive index layer 13 depending on the refractive index of the variable refractive index layer 13, and emits the visible light rays VL out of the variable refractive index layer 13 from different positions of the variable refractive index layer 13. The visible light rays VL are then incident at different angles of incidence through the substrate 15 to different positions in the optical layer 17.

The optical layer 17 reflects the visible light rays VL emitted from the variable refractive index layer 13 from different positions of the optical layer 17 toward the variable refractive index layer 13. In the second variation, the optical layer 17 diffusely reflects the plurality of visible light rays VL emitted from the variable refractive index layer 13 from different positions of the optical layer 17 toward the variable refractive index layer 13. Accordingly, the diffusely reflected visible light rays VL with mutually different wavelengths are incident to the eyes of a person viewing the display section 1 from the side of the main surface 19a of the substrate 19. The positions where the visible light rays VL are diffusely reflected in the optical layer 17 are close to each other and are the same position to the eyes of a person. As a result, a person can see a color image expressed by the visible light rays VL.

In particular, in the second variation, among the white light WL, green visible light LG, red visible light LB, and blue visible light LB are introduced into the variable refractive index layer 13 at different angles from different positions of the variable refractive index layer 13 and are emitted out of the variable refractive index layer 13 from different positions of the variable refractive index layer 13.

The optical layer 17 diffusely reflects the green visible light LG, the red visible light LB, and the blue visible light LB emitted from the variable refractive index layer 13 from different positions in the optical layer 17 toward the variable refractive index layer 13. As a result, the display section 1A can perform color display with the visible light LB, the visible light LG, and the visible light LB.

Specifically, in the pixel PX2 to which the light introduction mode is set, the visible light LR included in the white light WL is introduced from the optical waveguide layer 11 into the variable refractive index layer 13 and transmitted through the pixel electrode 2131b and the substrate 15. The visible light LR is then diffusely reflected by the minimum unit portion MU2 of the optical layer 17 facing the pixel electrode 2131b. That is, the pixel PX2 emits the red visible light LR.

In a pixel PX3 to which the light introduction mode is set, the visible light LG included in the white light WL is introduced from the optical waveguide layer 11 to the variable refractive index layer 13 and transmitted through a pixel electrode 2131c and the substrate 15. The visible light LG is then diffusely reflected by the minimum unit portion MU2 of the optical layer 17 facing the pixel electrode 2131c. That is, the pixel PX3 emits the green visible light LG.

Furthermore, in a pixel PX4 to which the light introduction mode is set, the visible light LB included in the white light WL is introduced from the optical waveguide layer 11 to the variable refractive index layer 13 and transmitted through a pixel electrode 2131d and the substrate 15. The visible light LB is then diffusely reflected by the minimum unit portion MU2 of the optical layer 17 facing the pixel electrode 2131d. That is, the pixel PX4 emits the blue visible light LB.

As a result, the display section 1A can perform color display using the pixel PX2, the pixel PX3, and the pixel PX4 to which the light introduction mode is set.

Here, the pixels PX2, PX3, and PX4 are arranged adjacent to each other in a row. The pixels PX2, PX3, and PX4 diffusely reflect the respective visible light LR, LG, and LB corresponding to the respective three primary colors. Accordingly, each of the pixels PX2, PX3, and PX4 can be regarded as a sub-pixel. As a result, in a color display, the pixels PX2, PX3, and PX4 substantially constitute one pixel.

Note that by changing the orientation of the liquid crystal LQ in the variable refractive index layer 13, the visible light rays VL with different wavelengths can be introduced to the variable refractive index layer 13 from different positions in the optical waveguide layer 11. For example, in the variable refractive index layer 13, the orientation of the liquid crystal LQ at the pixel PX2, the orientation of the liquid crystal LQ at the pixel PX3, and the orientation of the liquid crystal LQ at the pixel PX3 are mutually different. That is, by controlling the orientation of the liquid crystal LQ according to the wavelength of the visible light VL to be introduced to the variable refractive index layer 13, the visible light rays VL with different wavelengths can be removed from the white light WL corresponding to the respective pixels PX.

### Third Embodiment

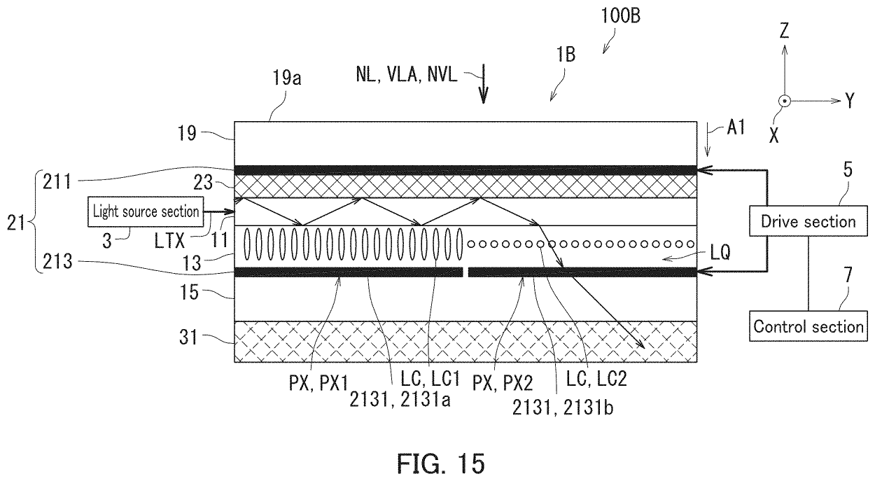

A display device 100B according to a third embodiment of the present invention is described with reference to FIG. 15. The third embodiment mainly differs from the display device 100A according to the second embodiment described with reference to FIG. 10 in that the display device 100B in the third embodiment has an optical layer 31 that absorbs light LTX. The following describes the main points of difference between the third embodiment and the second embodiment.

FIG. 15 is a cross-sectional view of the display device 100B in the third embodiment. As illustrated in FIG. 15, the display device 100B includes a display section 1B instead of the display section 1A of the display device 100A illustrated in FIG. 10. The display section 1B includes an optical layer 31 instead of the optical layer 17 of the display section 1A illustrated in FIG. 10. The variable refractive index layer 13 is disposed between the optical waveguide layer 11 and the optical layer 31.

In the third embodiment, the light source section 3 emits the light LTX toward the optical waveguide layer 11. Accordingly, the light LTX is guided through the optical waveguide layer 11. As long as the optical layer 31 can be colored, the light LTX may be visible light or invisible light. Otherwise, like the light LT described with reference to FIG. 10, the light LTX is either guided through the optical waveguide layer 11 and emitted from the emission end, or introduced to the variable refractive index layer 13 and is then incident to the optical layer 31, depending on the refractive index of the variable refractive index layer 13. That is, depending on the refractive index of the minimum unit portion MU1 of the liquid crystal LQ in a pixel PX, the state of the pixel PX is set to the optical waveguide mode or the light introduction mode.

The optical layer 31 absorbs and colors the light LTX emitted from the variable refractive index layer 13. Accordingly, the difference in lightness and darkness can be increased between a portion where the optical layer 17 is not colored and a portion where the optical layer 17 is colored. As a result, the display device 100B can exhibit improved contrast and display a high-quality image. In addition, a person viewing the display section 1 from the side of the main surface 19a of the substrate 19 can see the colored portion of the optical layer 31.

A portion of the optical layer 17 that is not colored is a portion where the light LTX is not being incident and is transparent.

Specifically, in the pixel PX2 set to the light introduction mode, the minimum unit portion MU2 of the optical layer 31 absorbs the light LTX emitted from the variable refractive index layer 13 and colors the light LTX. By contrast, in the pixel PX1 set to the optical waveguide mode, the light LTX is not incident to the minimum unit portion MU2 of the optical layer 31, so that the minimum unit portion MU2 of the optical layer 31 does not color the light LTX. Accordingly, the pixel PX1 is transparent. As a result, the difference in brightness and darkness between the uncolored pixel PX1 and the colored pixel PX2 can be increased, thereby improving contrast.

The optical layer 31 is composed of a photochromic material, for example. A photochromic material is a material that is colored by light irradiation. For example, the photochromic material is colored by ultraviolet light irradiation. In this case, the light source section 3 emits ultraviolet light as the light LTX. The photochromic material includes a spiro compound or a diarylethene compound, for example.

Note that the optical layer 31 may be composed of an electrochromic material, for example. An electrochromic material is a material that reversibly changes color when an electric current or a voltage is applied. In this case, the display device 100B further includes a power supply (unillustrated) that applies a current or voltage to the electrochromic material. The power supply includes a power supply circuit, for example.

The optical layer 31 may be disposed between the pixel electrode group 213 and the substrate 15. Furthermore, the optical layer 31 illustrated in FIG. 15 may be provided instead of the optical layer 17 of the display device 100 illustrated in FIG. 1 (including variations). In this case, the optical layer 31 may be disposed between the variable refractive index layer 13 and the substrate 15.

### Fourth Embodiment

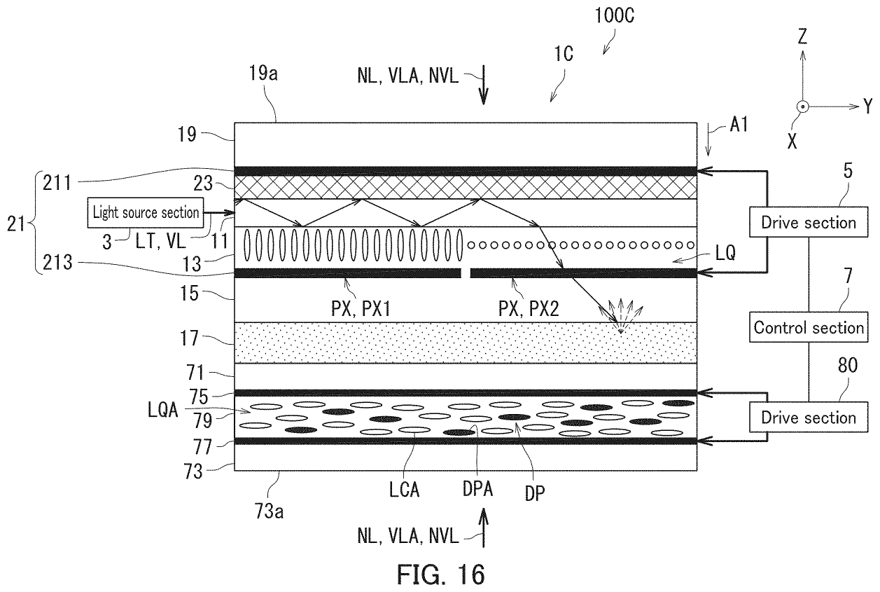

A display device 100C according to a fourth embodiment of the present invention is described with reference to FIG. 16. The fourth embodiment mainly differs from the second embodiment in that the display device 100C in the fourth embodiment has a variable absorptance layer 79. The following describes the main points of difference between the fourth embodiment and the second embodiment.

FIG. 16 is a cross-sectional view of the display device 100C in the fourth embodiment. As illustrated in FIG. 16, the display device 100C further includes a drive section 80 in addition to the configuration of the display device 100A illustrated in FIG. 10. The control section 7 controls the drive section 80. A display section 1C of the display device 100C includes a display section 1C instead of the display section 1A of the display device 100A illustrated in FIG. 10. In addition to the configuration of the display section 1A illustrated in FIG. 10, the display section 1C further includes a first substrate 71, a second substrate 73, a first electrode 75, a second electrode 77, and a variable absorptance layer 79.

The variable absorptance layer 79 is disposed opposite to the variable refractive index layer 13 with respect to the optical layer 17. Specifically, the first substrate 71 and the optical layer 17 face each other. The first electrode 75, the variable absorptance layer 79, and the second electrode 77 are disposed between the first substrate 71 and the second substrate 73. The variable absorptance layer 79 is disposed between the first electrode 75 and the second electrode 77. Each of the first substrate 71, the second substrate 73, the first electrode 75, the second electrode 77, and the variable absorptance layer 79 is clear and transparent. Each of the first substrate 71, the second substrate 73, the first electrode 75, the second electrode 77, and the variable absorptance layer 79 is preferably flexible. Each of the first electrode 75 and the second electrode 77 is composed of ITO, for example. Note that in FIG. 16, the first electrode 75 and the second electrode 77 are illustrated in black to facilitate understanding of the disposal thereof.

The drive section 80 applies a control voltage Vt to the variable absorptance layer 79 to drive the variable absorptance layer 79. The drive section 5 includes a power supply circuit, for example. Specifically, the drive section 80 applies the control voltage Vt to the variable absorptance layer 79 via the first electrode 75 and the second electrode 77.

The variable absorptance layer 79 switches, according to the applied control voltage Vt, between a state in which light is transmitted and a state in which light is absorbed. Therefore, according to the fourth embodiment, when the state of the variable absorptance layer 79 is a state in which light is transmitted, both the ambient light NL incident from the side of the substrate 19 and the ambient light NL incident from the side of the second substrate 73 are transmitted through the variable absorptance layer 79. As a result, the display section 1C can effectively function as a transparent display. When the state of the variable absorptance layer 79 is a state in which light is absorbed by contrast, both the ambient light NL incident from the side of the substrate 19 and the ambient light NL incident from the side of the second substrate 73 are absorbed by the variable absorptance layer 79. Accordingly, the background of the display section 1C appears dark to a person viewing the display section 1 from the side of the main surface 19a of the substrate 19. As a result, the difference in lightness and darkness between a portion where the optical layer 17 reflects the light LT (the pixel PX2, for example) and a portion where the optical layer 17 does not reflect the light LT (the pixel PX1, for example) can be further increased. In other words, the display device 100C can exhibit further improved contrast and display an even higher-quality image.

Specifically, the variable absorptance layer 79 includes liquid crystal LQA and dichroic pigment DP. The dichroic pigment DP is a pigment in which absorbance in the long axis direction of molecules differs from absorbance in the short axis direction of the molecules. For example, in the dichroic pigment DP, the absorbance in the long axis direction of the molecules is greater than the absorbance in the short axis direction of the molecules.

More specifically, the dichroic pigment DP is added to the liquid crystal LQA. The liquid crystal LQA includes a plurality of liquid crystal molecules LCA. The dichroic pigment DP includes a plurality of dichroic pigment molecules DPA. The dichroic pigment molecules DPA are added between the liquid crystal molecules LCA.

The dichroic pigment DP is DCM or BTBP, for example. DCM refers to [2-[2-[4-(Dimethylamino)phenyl]ethenyl]-6-methyl-4H-pyran-4-ylidene]propanedinitril e. BTBP refers to N,N′-bis(2,5-di-tert-butylphenyl)-3,4,9,10-perylenedicarboimide. However, the type of the dichroic pigment DP is not particularly limited. For example, the dichroic pigment DP may be a dichroic pigment described in “Dichroic Dyes for Liquid Crystal Displays” (CRC Press, 1994), by Aleksandr V. Ivashchenko.

Note that each of the display device 100 illustrated in FIG. 1 (including the variation), the display device 100A illustrated in FIG. 10 (including the first and second variations), and the display device 100B illustrated in FIG. 15 may further include the drive section 80, the first substrate 71, the second substrate 73, the first electrode 75, the second electrode 77, and the variable absorptance layer 79 illustrated in FIG. 16.

Embodiments of the present invention are described above with reference to the accompanying drawings. However, the present invention is not limited to the above embodiments, and can be implemented in various ways without departing from the gist thereof. In addition, the plurality of constituent elements disclosed in the above embodiments can be altered as appropriate. For example, some constituent elements among all of the constituent elements illustrated in one embodiment may be added to the constituent elements of another embodiment, or some constituent elements among all of the constituent elements illustrated in one embodiment may be removed from the embodiment.

The drawings illustrate each constituent element mainly in a schematic manner to facilitate understanding of the invention. Aspects such as the thickness, length, number, and interval of each constituent element illustrated in the drawings may differ in practice for convenience of drawing preparation. It also need not be stated that the configuration of each constituent element illustrated in the above embodiments is an example and is not a particular limitation. Various changes can be made without substantially deviating from the effects of the present invention.

### INDUSTRIAL APPLICABILITY

The present invention provides a display device, and has industrial applicability.

### REFERENCE SIGNS LIST

1, 1A, 1B, 1C Display section
3 Light source section
3W White light source
4, 4R, 4G, 4B Light source
11 Optical waveguide layer
17, 31 Optical layer
21 Electrode unit
23 Cladding layer
79 Variable absorptance layer
171 Helical structure
180 Layered structure
181 Substrate
183 Dielectric multilayer film
LQ Liquid crystal

1. A display device comprising:
an optical waveguide layer configured to guide light;
a variable refractive index layer with a refractive index that changes in response to application of a drive voltage; and
an optical layer configured to reflect or absorb light, wherein
the variable refractive index layer is disposed between the optical waveguide layer and the optical layer,
the variable refractive index layer
reflects the light to be guided through the optical waveguide layer toward the inside of the optical waveguide layer depending on the refractive index of the variable refractive index layer to allow the optical waveguide layer to guide the reflected light, and
introduces the light to be guided through the optical waveguide layer into the variable refractive index layer depending on the refractive index of the variable refractive index layer and emits the introduced light out of the variable refractive index layer, and
the optical layer reflects or absorbs the light emitted from the variable refractive index layer.

2. The display device according to claim 1, wherein
the variable refractive index layer is a liquid crystal layer including liquid crystal.

3. The display device according to claim 1, wherein
the optical layer diffusively reflects the light emitted from the variable refractive index layer.

4. The display device according to claim 1, wherein
the optical layer includes a plurality of helical structures or a layered structure,
each of the helical structures extends in a direction intersecting with the variable refractive index layer,
spatial phases of two or more of the helical structures are mutually different, and
the layered structure includes a substrate with an irregular surface and a dielectric multilayer film laminated to the surface of the substrate.

5. The display device according to claim 1, further comprising
a light source section configured to emit the light toward the optical waveguide layer such that the light is guided through the optical waveguide layer, wherein
the light emitted by the light source section includes visible light,
the variable refractive index layer
reflects the visible light to be guided through the optical waveguide layer toward the inside of the optical waveguide layer depending on the refractive index of the variable refractive index layer to allow the optical waveguide layer to guide the reflected visible light, and
introduces the visible light to be guided through the optical waveguide layer into the variable refractive index layer depending on the refractive index of the variable refractive index layer and emits the introduced visible light out of the variable refractive index layer,
the optical layer reflects the visible light introduced from the optical waveguide layer and emitted from the variable refractive index layer,
the optical waveguide layer transmits ambient light incident at an angle at which the ambient light cannot be guided through the optical waveguide layer,
the variable refractive index layer transmits the ambient light transmitted through the optical waveguide layer, and
the optical layer transmits visible light included in the ambient light transmitted through the variable refractive index layer.

6. The display device according to claim 5, wherein
the light source section includes a plurality of light sources which emit visible light rays with mutually different wavelengths, and
the light sources emit the visible light rays toward the optical waveguide layer at mutually different timings.

7. The display device according to claim 5, wherein
the light source section includes a white light source which emits white light,
the white light source emits the white light toward the optical waveguide layer, and
the variable refractive index layer introduces a plurality visible light rays with mutually different wavelengths included in the white light at different angles from different positions of the variable refractive index layer depending on the refractive index of the variable refractive index layer, and emits the visible light rays out of the variable refractive index layer from different positions of the variable refractive index layer.

8. The display device according to claim 1, wherein
the optical layer absorbs and colors the light emitted from the variable refractive index layer.

9. The display device according to claim 1, further comprising:
an electrode unit configured to apply the drive voltage to the variable refractive index layer; and
a cladding layer with a refractive index that is smaller than the refractive index of the optical waveguide layer, wherein
the optical waveguide layer is disposed between the cladding layer and the variable refractive index layer.

10. The display device according to claim 1, further comprising:
a variable absorptance layer configured to switch, according to an applied control voltage, between a state in which light is transmitted and a state in which light is absorbed, wherein
the variable absorptance layer is disposed opposite to the variable refractive index layer with respect to the optical layer.
